(19) United States
(12) Patent Application Publication
(10) Pub. No.: US 2004/0210688 A1
(43) Pub. Date: Oct. 21, 2004

(54) Aggregating data

(76) Inventor: Matthew E. Becker, Harvard, MA (US)

Correspondence Address: FISH & RICHARDSON, PC, 12390 EL CAMINO REAL, SAN DIEGO, CA, 92130-2081, US

(21) Appl. No.: 10/420,360

(22) Filed: Apr. 21, 2003

(51) Int. Cl. G06F 3/00

(52) U.S. Cl. 710/58

(57) ABSTRACT

A system for aggregating data includes aggregation mechanisms. Each aggregation mechanism is configured to receive data from incoming ports and aggregate timing information for the incoming ports before determining where to route the data from outgoing ports. The system may include line cards. Each line card may be configured to transmit data to the aggregate mechanisms.

### BACKGROUND

This description relates to aggregating data.

Data communication systems may use a fabric to connect and pass data between system components. A simple form of fabric uses a single stage crossbar. The crossbar can connect any of the fabric's inputs to any of its outputs, enabling passage of data between the inputs and outputs. The maximum configuration of a fabric using a single stage crossbar is typically limited by the number of ports supported by a single crossbar chip and any bandwidth requirements on each port, such as the number of pins required per port. Common timing may be used from a source of data to the crossbar chip to increase the bandwidth achievable per pin, where realizing common timing typically consumes part or all of one pin per port.

### DESCRIPTION OF DRAWINGS

FIG. 1 is a block diagram of an example switching network.

FIG. 2 is a flowchart showing an example process of aggregating data.

FIG. 3 is a block diagram of an example 128-component signaling system without aggregators.

FIG. 4 is a block diagram of another example of the 128-component signaling system with aggregators.

FIG. 5 is a block diagram of an example network configuration.

### DESCRIPTION

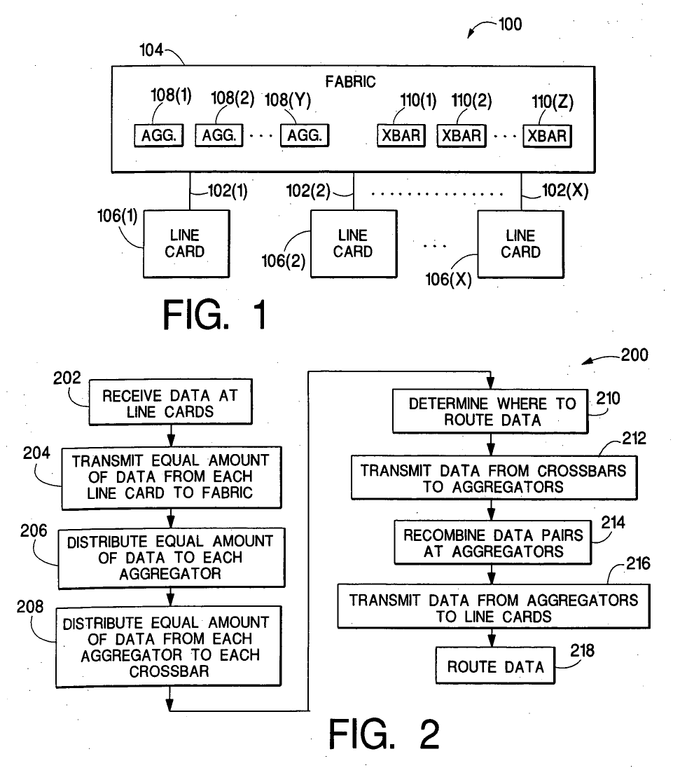

Referring to FIG. 1, an example switching device 100 (“switch 100”) includes a fabric 104 and line cards 106(1)-106(X). The switch is simplified for ease of explanation and may include more elements than shown in this example. The switch 100 can determine where to direct data that arrives at the switch 100 via the line cards 106(1)-106(X). The fabric 104 includes one or more aggregators 108(1)-108(Y) and one or more crossbars 110(1)-110(Z) that may be used by the switch 100 to help redirect data entering the switch 100 at one of the line cards 106(1)-106(X) to one or more of the other line cards 106(1)-106(X). X, Y, and Z each equal any positive whole number. X, Y, and Z may all be equal, may all differ, or may equal one of the two other values. Crossbars 110(1)-110(Z) may include functionality of an arbiter that may use an arbitration scheme to help control the flow of data through the crossbars 110(1)-110(Z) to the aggregators 108(1)-108(16).

The line cards 106(1)-106(X) are the switch's ports, and data arrives at the switch 100 through the line cards 106(1)-106(X). (The switch 100, however, may include additional ports.) Each of the line cards 106(1)-106(X) may connect to the fabric 104 through, respectively, direct point-to-point connection links 102(1)-102(X) or any other type of direct or indirect connection links.

A line card that receives data can forward the data along its associated connection link to the fabric 104. The fabric in this example is a single stage fabric, but in other example switching devices the fabric may have multiple stages, with proper scaling. If the data includes more than one packet, the line card that received the data may forward one or more packets at a time. The data may be transmitted from the line card that received the data to one or more of the other line cards 106(1)-106(X) as directed by the fabric 104.

In processing data received from the line cards 106(1)-106(X), the fabric 104 can use the aggregators 108(1)-108(Y) to aggregate multiple ports so that they can share timing information (e.g., be synchronized at the aggregators 108(1)-108(Y) to the same timing) before hitting one or more of the crossbars 110(1)-110(Z), e.g., before the crossbars 110(1)-110(Z) determine where to route data from the multiple ports. Using the aggregators 108(1)-108(Y) to share timing information can increase the effective bandwidth per port and reduce the number of pins required per port. The time sharing may also decouple the fabric's underlying signaling technique (e.g., how many ports share common timing) from its maximum configurable size.

FIG. 2 shows an example process 200 of aggregating data. Although the process 200 is described with reference to the example switch 100 of FIG. 1, this or a similar process, including the same, more, or fewer elements, reorganized or not, may be performed using the switch 100 or using another, similar system.

In the process 200, the switch 100 receives 202 data at the line cards 106(1)-106(X). The switch 100 may receive data from any number and any type of sources such as computers, switching devices, and servers that transmit data over a network to the switch 100.

The line cards 106(1)-106(X) each transmit 204 an equal amount of data to the fabric 104. For example, each of the line cards 106(1)-106(X) may transmit shared ports of data (data on two pins) to the fabric 104, where the number of pins used per port may have a required minimum. The fabric 104 can equally distribute 206 the data from the line cards 106(1)-106(X) to the aggregators 108(1)-108(Y). The fabric 104 can distribute the data in any way, such as through a round robin scheme, a scheme based on available load of the aggregators 108(1)-108(Y), a pre-determined distribution scheme (e.g., particular line card pins always deliver to the same aggregator pins) a priority scheme, or any other type of similar scheme.

The aggregators 108(1)-108(Y) can each equally distribute 208 their respective received data to each of the crossbars 110(1)-110(Z). The aggregators 108(1)-108(Y) can distribute their respective received data in any way, such as through a round robin scheme, a scheme based on available load of the crossbars 110(1)-110(Z), a pre-determined distribution scheme, a priority scheme, or any other type of similar scheme. In other words, the aggregators 108(1)-108(Y) can each aggregate data they receive from multiple line cards to share timing before the data reaches the crossbars 110(1)-110(Z) that provide the actual data switching.

The crossbars 110(1)-110(Z) each determine 210 where to route data sent to it by the aggregators 108(1)-108(Y). Generally, a crossbar determines which of the line cards 106(1)-106(X) should receive the data at that crossbar from which other one or ones of the line cards 106(1)-106(X) in order to properly route the data through the switch 100 en route to the data's destination.

After performing its data switching functions, the crossbars 110(1)-110(Z) can each transmit 212 data back to the appropriate aggregators 108(1)-108(Y). The flow of data from the crossbars 110(1)-110(Z) to the aggregators 108(1)-108(Y) may be controlled, such as through an arbitration scheme that flows data in a particular order from the crossbars 110(1)-110(Z), according to data priority, Quality of Service (QoS) requirements, and/or according to other criteria.

The aggregators 108(1)-108(Y) each recombine 214 data they receive from the crossbars 110(1)-110(Z) into pair data sets (if the data was sent from the line cards 106(1)-106(Z) as data pairs) and transmit 216 data to the appropriate one or ones of the line cards 106(1)-106(X). For example, crossbar 110(1) may determine that data from line card 106(1) needs to go to line card 106(2) because line card 106(2) is a port with connectivity to the data's next stop on a network. The fabric 104 may thus transmit that data from the crossbar 110(1) to aggregator 108(1) and from aggregator 108(1) to line card 106(2).

Having received data from the fabric 104, the line cards 106(1)-106(X) may transmit 218 data to their next stops, e.g., to other stops (e.g., switches, routers, servers, clients, etc.) on the network on their way to their destinations as determined by the crossbars 110(1)-110(Z).

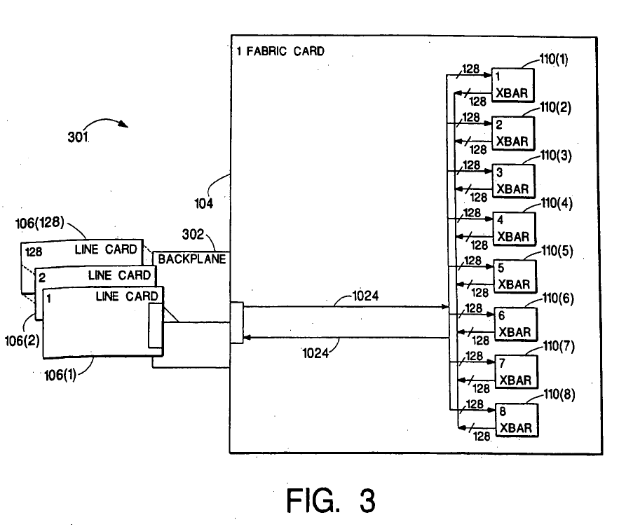

Referring to FIG. 3, one example of a switch configuration 301 shows an example configuration for the switch 100 of FIG. 1 without aggregators. The switch configuration 301 includes one hundred twenty-eighty line cards 106(1)-106(128) and the fabric 104, which includes eight crossbars 110(1)-110(8). In order to achieve full connectivity, each line card can send only one port to each crossbar which limits the underlying physical interconnect.

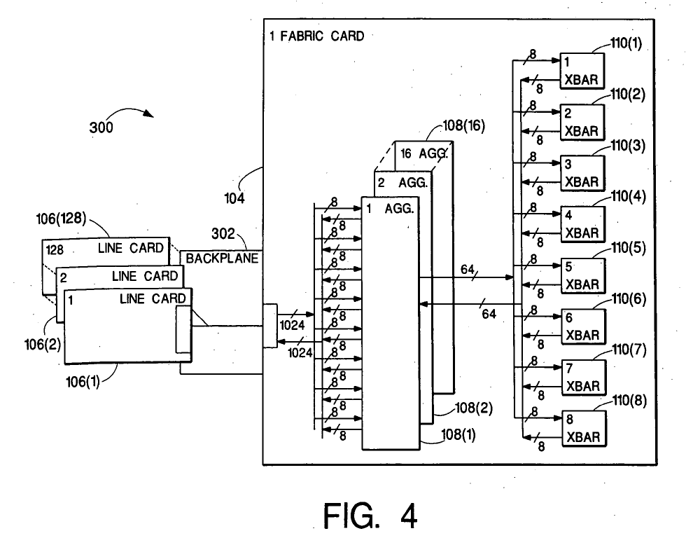

Referring to FIG. 4, another example of a switch configuration 300 shows an example configuration for the switch 100 of FIG. 1. The switch configuration 300 includes one-hundred twenty-eight line cards 106(1)-106(128) and the fabric 104, which includes sixteen aggregators 108(1)-108(16) and eight crossbars 110(1)-110(8). The line cards 106(1)-106(128), the fabric 104, the aggregators 108(1)-108(16), and the crossbars 110(1)-110(8) are all implemented as chips in this example.

The switch configuration 300 also includes a backplane 302 that can provide a connection between the line cards 106(1)-106(128) and the fabric 104. For example, the backplane 302 may include a socket card that the line cards 106(1)-106(128) and the fabric 104 may each plug into and establish an electrical connection. Backplane 302 may include wires, optical guides, and so forth.

In this example of a switch configuration 300, the first 8 of the 128 line cards 106(1)-106(128) can send all eight outgoing ports of data to the first aggregator 108(1) for a total of 64 ports. The second 8 of the 128 line cards can send all eight outgoing ports of data to the second aggregator 108(2). And so on, for the total of 1024 outgoing ports. The aggregators 108(1)-108(16) can take the data included in the eight pairs and distribute it equally to each of the crossbars 110(1)-110(8) such that each of the aggregators 108(1)-108(16) transmits sixty-four pairs, eight pairs to each of the crossbars 110(1)-110(8). Data can flow back from the crossbars 110(1)-110(8) to the line cards 106(1)-106(128) in the same proportions. For example, a switch including sixty-four ports (e.g., line cards) with a minimum signaling width on the physical layer of eight pins per port can be scaled using the same signaling scheme to the switch configuration 300 and include one hundred twenty-eight ports by including aggregators in the fabric capable of aggregating multiple ports so that the ports can share timing information before hitting the crossbars.

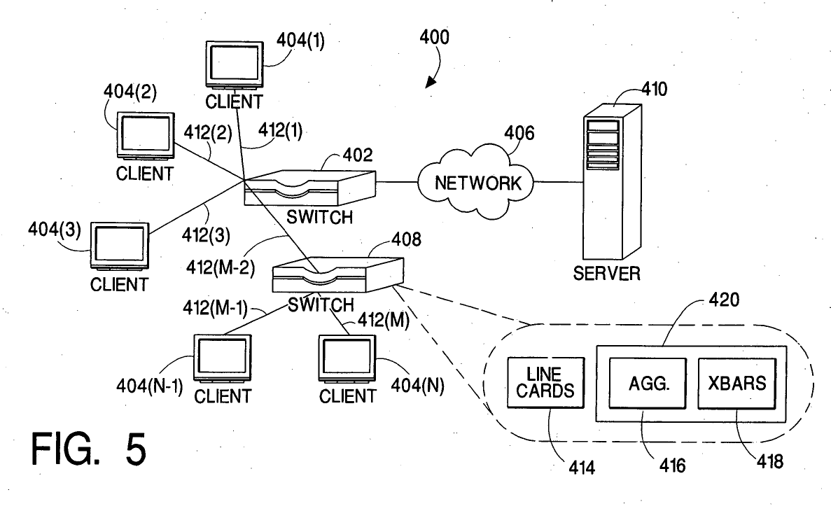

Referring to FIG. 5, an example network configuration 400 includes a switch 402 that may be implemented similar to the switch 100 of FIG. 1. The switch 402 can route packets between a network 406 and network endpoints such as clients 404(1)-401(N), where N equals any positive whole number. Clients 404(1)-404(3) are directly accessible from the switch 402, whereas clients 404(N−1) and 404(N) are accessible to the switch 402 through another switch 408.

When a server 410 sends data (assumed for simplicity in this example to include one packet) to the network 406 and the packet reaches the switch 402, the switch 402 can determine whether and where to forward the packet using line cards 414, aggregators 416, and crossbars 418 that may help route the packet. The switch 402 may include routing lookup capabilities enabling the switch 402 to examine packets, look up the packet's routing information in the switch's routing table(s), and appropriately route or drop the packet using one or more routing protocols. If the switch 402 determines that the packet should be forwarded to one or more destinations “behind” the switch 402, the switch 402 can send the packet (or a copy of the packet) via one or more of the line cards 414 for communication to the destination(s) on the appropriate communication links 412(1)-412(M), where M equals any positive whole number.

The switch 402 includes at least (M−1) line cards 414, one line card for each of (M−2) communication links 412(1)-412(M−2) available to communicate to and/or from the switch 402 and one line card for a communication link between the switch 402 and the network 406. M can equal any positive whole number. The number of line cards may be limited by the number of plug-ins that the switch 402 can support.

In packet forwarding, the switch 402 may use a data path and a control path. The data path's functions can include making a forwarding decision, sending a packet over a fabric 420 included in the switch 402 to the appropriate port(s) included in the switch 402, such as to the line cards 414, and maintaining the packet in line behind more urgent packets, e.g., buffering packets and ensuring quality of service (QoS). The control path's functions can include implementing the routing protocols used by the switch 402. The control path may include elements to implement policies, algorithms, mechanisms, and signaling protocols to manage internal data and control circuits, extract routing and protocol information from the packet and convey that information to control the data path, collect data path information such as traffic statistics, and handle some control messages.

The elements described can be implemented in a variety of ways.

The clients 404(1)-404(N) can each include any mechanism or device capable of communicating data with one or more switches (e.g., the switch 100, 300, 301, 402, 408, and other similar types of switches). Examples of the clients 404(1)-404(N) include workstations, stationary personal computers, mobile personal computers, servers, personal digital assistants, pagers, telephones, and other similar mechanisms and devices. The clients 404(1)-404(N) may differ from each other and may include any combination of same or different devices. Each of the clients 404(1)-404(N) is shown connected to one switch via one communication link, but each of the clients 404(1)-404(N) may be connected to more than one switch and may communicate with a switch using any variety of communication links.

The server 410 can include any device capable of communicating with the network 406 such as a file server, an application server, a database server, a mail server, a proxy server, a web server, a mobile computer, a stationary computer, or other similar type of device.

The switches 100, 300, 301, 402, and 408 can each include a switching device capable of directing information to and/or from the network elements such as the clients 404(1)-404(N), the network 406, the server 410, and other similar types of network elements. Examples of the switches 100, 300, 301, 402, and 408 include devices capable of forwarding network traffic (e.g., data, packets, cells, etc.) and/or making decisions on where to send network traffic on its way to its destination. Example of the switches 100, 300, 301, 402, and 408 include switches, routers (including switching routers), traffic shapers, combination router and traffic shapers, and other similar devices. The switches 100, 300, 301, 402, and 408 may operate at the data link layer (layer 2) and/or the network layer (layer 3) of the Open System Interconnection (OSI) Reference Model and support any packet protocol.

The network 406 can include any kind and any combination of networks such as an Internet, a local area network (LAN), a wide area network (WAN), a private network, a public network, or other similar type of network. The network 406 may include one or more individual networks.

The line cards 106(1)-106(X) and 414 can each include any mechanism (software, hardware, or a combination of the two) each capable of providing a transmitting/receiving port and accepting and buffering data for transmission to another mechanism or device. A port generally refers to a pathway into and/or out of a computer or network device such as a switch. For example, serial and parallel ports on a personal computer are external sockets for plugging in communications lines, modems and printers, and network adapters include ports (Ethernet, Token Ring, etc.) for connection to a local area network (LAN) or other public or private network. The line cards 106(1)-106(X) and 414 may each include a printed circuit board, for example, and may plug into a switch, a router, or other communications device, such as through a backplane.

The backplane 302 generally refers to an interconnecting device such as a circuit board or card that may or may not have intelligence but typically includes sockets that cards and boards can plug into. Although resistors may be used, a passive backplane adds no processing in the circuit including the backplane. An intelligent or active backplane may perform processing functions.

The fabrics 104 and 420 may each include any interconnect architecture capable of redirecting data between two or more ports of a switching device.

The aggregators 108(1)-108(Y) and 416 may each include any mechanism capable of processing data and aggregating timing information for two or more ports associated with the data. The aggregators 108(1)-108(Y) and 416 may include one or more chips. Further, the aggregators may be implemented as a stand-alone device or they may be integrated into the line card, the crossbars or both.

The crossbars 110(1)-110(Z) and 418 may each include any single or multi-stage mechanism capable of enabling data passage between two or more ports of a switching device. The crossbars 110(1)-110(Z) and 418 may include one or more chips.

Data transmitted between elements may be transmitted as blocks of data generally referred to as packets. A unit of packet data could include an entire network packet (e.g., an Ethernet packet) or a portion of such a packet. The packets may have a variable or a fixed size. Packets with a fixed size are called cells. Each sent packet may be part of a packet stream, where each of the packets, called a segment, included in the packet stream fits together to form a contiguous stream of data. Data may be communicated between endpoints via multicast, unicast, or some combination of both.

Data can be communicated between elements on communication links, e.g., the communication links 412(1)-412(M). The communication links can include any kind and any combination of communication links such as buses, physical ports, modem links, Ethernet links, cables, point-to-point links, infrared connections, fiber optic links, wireless links, cellular links, Bluetooth, satellite links, and other similar links. Additionally, each of the communication links may include one or more individual communication links.

Furthermore, the switches 100, 300 and 301 and the network configuration 400 are simplified for ease of explanation. The switches may include more or fewer additional elements such as routing lookup tables, ports, pins, and other types of switch or router elements. The network configuration 400 may include more or fewer additional elements such as networks, communication links, servers, hubs, bridges, switches, routers, processors, storage locations, firewalls or other security mechanisms, Internet Service Providers (ISPs), and other types of network elements.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile computers, stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

This disclosure is not limited to the examples described nor are the examples limited to network processor and crossbar configurations. For example, this disclosure may be implemented in any fabric such as a multiprocessor system, a memory storage machine or local networks within a particular machine.

Process 200 is not limited to the specific processing order of FIG. 2. Rather, the blocks of FIG. 2 may be re-ordered, as necessary, to achieve the results set forth above.

Other embodiments are within the scope of the following claims.

What is claimed is:

1. A system comprising:
aggregation mechanisms, each aggregation mechanism configured to:
receive data from incoming ports, and
aggregate timing information for the incoming ports before routing the data from outgoing ports.

2. The system of claim 1 further comprising line cards, each line card configured to transmit data to the aggregation mechanisms.

3. The system of claim 2 in which each of the line cards is configured to transmit data on a number of pins, and
each of the aggregation mechanisms is configured to receive data from an equal number of pins.

4. The system of claim 1 further comprising crossbars, each of the crossbars configured to:
route data from the incoming ports to the outgoing ports.

5. The system of claim 1 in which each of the aggregation mechanisms is configured to transmit an equal amount of data to each of the crossbars.

6. The system of claim 5 further comprising an arbitration mechanism configured to control the crossbars, the arbitrator located with the crossbars.

7. The system of claim 1 further comprising a fabric configured to:
receive data from the incoming ports,
aggregate the timing of the incoming ports, and
determine where to route the data from the outgoing ports.

8. A system comprising:
a fabric configured to route data;
crossbars included in the fabric, each of the crossbars configured to determine routing for data; and
aggregation mechanisms included in the fabric, each aggregator configured to
receive an equal amount of data to be routed, and
distribute an equal amount of data to the crossbars.

9. The system of claim 8 further comprising line cards, each line card configured to receive data to be routed and to transmit the data to the fabric on one or more pins.

10. The system of claim 9 in which each of the aggregation mechanisms is configured to receive data from an equal number of pins.

11. The system of claim 8 further comprising a backplane configured to connect the line cards and the fabric.

12. A method comprising:
transmitting data to be routed through a network from incoming ports to aggregation chips;
transmitting data from a subset of the incoming ports to each of the aggregation chips; and
at each aggregation chip, sharing timing of the incoming ports associated with data received at that aggregation chip before determining where to route the data from outgoing ports.

13. The method of claim 12, further comprising: transmitting the data to be routed from the incoming ports on pins, and
receiving data from the same number of pins at each of the aggregation chips.

14. The method of claim 12, further comprising, after sharing timing at an aggregation chip, transmitting the data received at the aggregation chip to crossbars,
determining how to route the data at the crossbars, and
transmitting routing information for the data from the crossbars to the aggregation chip that transmitted the data and from the aggregation chip to the appropriate ones of the ports.

15. The method of claim 12 further comprising controlling, with an arbitration scheme, a flow of data between the arbitration chips and mechanisms configured to determine how to route the data.

16. An article comprising a machine-readable medium which contains machine-executable instructions, the instructions causing a machine to:
transmit data to be routed through a network from incoming ports to aggregation chips;
transmit data from a subset of the incoming ports to each of the aggregation chips; and
at each aggregation chip, share timing of the incoming ports associated with data received at that aggregation chip before determining where to route the data from outgoing ports.

17. The article of claim 16 further causing a machine to transmit the data to be routed from the incoming ports on pins, and
receive data from the same number of pins at each of the aggregation chips.

18. The article of claim 16 further causing a machine to, after sharing timing at an aggregation chip, transmit the data received at the aggregation chip to crossbars,
determine how to route the data at the crossbars, and
transmit routing information for the data from the crossbars to the aggregation chip that transmitted the data and from the aggregation chip to the appropriate ones of the ports.

19. The article of claim 16 further causing a machine to control, with an arbitration scheme, a flow of data between the arbitration chips and mechanisms configured to determine how to route the data.

20. A system comprising:
a switching device configured to:
receive data from a network on a communication link,
transmit an equal amount of data from each of line cards to each of aggregation chips, and
share timing of the line cards associated with the data received at an aggregation chip before determining how to route the data on the network from the switching device.

21. The system of claim 20 in which the switching device is configured to receive data from a client connected to the network.

22. The system of claim 20 in which the switching device is configured to receive data from another switching device connected to the network.

23. The system of claim 20 in which the switching device is also configured to
determine how to route data from routing information received by an aggregation chip, and
transmit the data and routing information for the data to the aggregator chip and from the aggregator chip to the line cards associated with the data.

24. The system of claim 20 further comprising crossbars configured to receive data from the aggregation chips and to determine how to route data.

25. The method of claim 1 wherein aggregating comprises:
using a standalone chip to aggregate.

26. The method of claim 1 wherein aggregating comprises:
integrating aggregation functionality into crossbars.

27. The method of claim 1, wherein aggregating comprises:
integrating into a first stage and a last stage of a multi-stage network.
